(19) United States
(12) Patent Application Publication
(10) Pub. No.: US 2019/0052177 A1
(43) Pub. Date: Feb. 14, 2019

(54) POWER ELECTRONIC CONVERSION UNIT AND SYSTEM

(71) Applicant: Delta Electronics (Shanghai) Co., Ltd., Shanghai (CN)

(72) Inventors: Cheng LU, Shanghai (CN); Wenfei HU, Shanghai (CN)

(21) Appl. No.: 16/026,007

(22) Filed: Jul. 2, 2018

(30) Foreign Application Priority Data
Aug. 10, 2017 (CN) 201710682155.1

(51) Int. Cl. H02M 3/335; H02M 7/5387; H02M 7/487; H02M 7/797

(52) U.S. Cl. CPC H02M 3/33569; H02M 7/797; H02M 7/487; H02M 7/5387

(57) ABSTRACT

Embodiments provide a power electronic conversion unit and system, where the power electronic conversion unit includes an AC/DC subunit, which is a three-level circuit and includes a direct current output port; a first bus capacitor subunit and a second bus capacitor subunit are connected in series and connected to the direct current output port of the AC/DC subunit; the first DC/DC subunit includes a first and a second half-bridge DC/AC sub-modules, a first capacitor unit and a first transformer, where the first and second half-bridge DC/AC sub-modules has their direct current input ports connected to the first and second bus capacitor subunits in parallel, respectively; the first and the second half-bridge DC/AC sub-modules respectively include a bridge arm neutral point, and the first capacitor unit connects the bridge arm neutral points of the first and the second half-bridge DC/AC sub-modules and a primary winding of a first transformer in series.

### CROSS-REFERENCE TO RELATED APPLICATION

This application claims priority to Chinese Patent Application No. 201710682155.1, filed on Aug. 10, 2017, which is hereby incorporated by reference in its entirety.

### TECHNICAL FIELD

Embodiments of the present disclosure relate to the technical field of power electronics and, in particular, to a power electronic conversion unit and system.

### BACKGROUND

With the development of distributed new energy power generation technology and the increase of direct current power equipment, the demand for low voltage direct current power distribution is rising. Conventional solutions generally use an industrial frequency transformer to convert a medium voltage alternating current (MVAC) into a low voltage alternating current first, and then use an AC/DC converter to convert the low voltage alternating current to a low voltage direct current (LVDC). A power electronic transformer (PET) is a device that achieves power conversion from MVAC to LVDC by using a high frequency isolation circuit, which has higher power density and efficiency compared to the conventional solutions based on the industrial frequency transformer.

FIG. 1 is a schematic structural diagram of a power electronic transformer system in the prior art. As shown in FIG. 1, a majority of existing power electronic transformers (PET) adopt the structure as shown in FIG. 1. The AC/DC converters that are cascaded at the front-stage convert an input MVAC into a plurality of intermediate direct currents. This front-stage structure is usually referred to as a CHB structure. The DC/DC converters at the rear-stage convert the intermediate direct currents into LVDC and perform a high frequency isolation, and output ends of the LVDC are connected in parallel. Each pair of AC/DC converter and DC/DC converter constitutes a modular power electronic conversion unit. In order to match a higher voltage level of the MVAC, the PET generally needs a large number of units for a serial connection at the alternating current side. A large number of cascaded units will result in increased complexity and costs for the system. The number of cascaded units depends on input voltage level of each unit; whereas input voltage level of the power electronic conversion unit depends on a topology of the units and power semiconductor devices used.

However, it is difficult to achieve a good balance between a withstand voltage of devices and a number of units with the structure of existing PET unit, complicated structure and high costs become a common problem.

### SUMMARY

Embodiments of the present disclosure provide a power electronic conversion unit and system to solve the technical problems that it is difficult to achieve a good balance between a withstand voltage of devices and a number of units with the structure of existing PET unit, the structure is complicated and the costs are high.

In a first aspect, an embodiment of the present disclosure provides a power electronic conversion unit, including: an AC/DC subunit, a first bus capacitor subunit, a second bus capacitor subunit and a first DC/DC subunit,

where the AC/DC subunit is a three-level circuit and includes a direct current output port;

the first bus capacitor subunit and the second bus capacitor subunit are connected in series and are connected to the direct current output port of the AC/DC subunit;

the first DC/DC subunit includes a first half-bridge DC/AC sub-module, a second half-bridge DC/AC sub-module, a first capacitor unit and a first transformer, where the first half-bridge DC/AC sub-module has its direct current input port connected to the first bus capacitor subunit in parallel; the second half-bridge DC/AC sub-module has its direct current input port connected to the second bus capacitor subunit in parallel; the first half-bridge DC/AC sub-module and the second half-bridge DC/AC sub-module respectively include a bridge arm neutral point, and the first capacitor unit connects the bridge arm neutral point of the first half-bridge DC/AC sub-module, the bridge arm neutral point of the second half-bridge DC/AC sub-module and a primary winding of the first transformer in series.

In a possible implementation, the power electronic conversion unit further includes a second DC/DC subunit, where the second DC/DC subunit includes a third half-bridge DC/AC sub-module, a fourth half-bridge DC/AC sub-module, a second capacitor unit and a second transformer, the third half-bridge DC/AC sub-module has its direct current input port connected to the first bus capacitor subunit in parallel; the fourth half-bridge DC/AC sub-module has its direct current input port connected to the second bus capacitor subunit in parallel; the third half-bridge DC/AC sub-module and the fourth half-bridge DC/AC sub-module respectively include a bridge arm neutral point, and the second capacitor unit connects the bridge arm neutral point of the third half-bridge DC/AC sub-module, the bridge arm neutral point of the fourth half-bridge DC/AC sub-module and a primary winding of the second transformer in series.

In a possible implementation, the AC/DC subunit is one of a neutral-point-clamped three-level full-bridge circuit, a flying capacitor three-level full-bridge circuit and a serial half-bridge circuit.

In a possible implementation, the first DC/DC subunit further includes a secondary side AC/DC conversion unit, and the secondary side AC/DC conversion unit has its alternating current port connected to a secondary winding of the first transformer.

In a possible implementation, the first DC/DC subunit further includes a passive network containing a capacitor and/or an inductor, and the secondary side AC/DC conversion unit is connected to the secondary winding of the first transformer via the passive network.

In a possible implementation, the passive network is one of a series resonant network and a parallel resonant network.

In a possible implementation, the secondary side AC/DC conversion unit is one of a full-bridge rectification circuit, a full-wave rectification circuit, and a bidirectional conversion circuit.

In a possible implementation, the AC/DC subunit and the first DC/DC subunit are bidirectional conversion circuits.

In a possible implementation, the second DC/DC subunit further includes a secondary side AC/DC conversion unit, and the secondary side AC/DC conversion unit has its alternating current port connected to a secondary winding of the second transformer.

In a possible implementation, the second DC/DC subunit is a bidirectional conversion circuit.

In a possible implementation, the power electronic conversion unit further includes a DC/DC converter, where the DC/DC converter has its direct current input port connected to a direct current output port of the secondary side AC/DC conversion unit.

In a possible implementation, the power electronic conversion unit further includes at least one DC/DC converter, where the at least one DC/DC converter has its direct current input port connected to a direct current output port of the secondary side AC/DC conversion unit.

In a second aspect, an embodiment of the present disclosure provides a power electronic conversion system, including a plurality of power electronic conversion units according to the first aspect.

In a possible implementation, the respective AC/DC subunits of the plurality of power electronic conversion units are full-bridge conversion units, and the plurality of power electronic conversion units have their first ports connected in series to form a cascaded H-Bridge structure.

In a possible implementation, the respective AC/DC subunits of the plurality of power electronic conversion units are one of full-bridge conversion circuits and half-bridge circuits, and the plurality of power electronic conversion units have their first ports connected in series to respectively form an upper bridge arm and a lower bridge arm of an MMC structure.

In a possible implementation, direct current ports of the plurality of secondary side AC/DC conversion units are one of all connected in parallel, all connected in series, partially connected in parallel and partially connected in series, and mutually disconnected from each other.

According to the power electronic conversion unit and system provided in the embodiments of the present disclosure, the AC/DC subunit is a three-level circuit and includes a direct current output port; the first bus capacitor subunit and the second bus capacitor subunit are connected in series and then connected to the direct current output port of the AC/DC subunit in parallel; the first DC/DC subunit includes a first half-bridge DC/AC sub-module, a second half-bridge DC/AC sub-module, a first capacitor unit and a first transformer, where the first half-bridge DC/AC sub-module has its direct current input port connected to the first bus capacitor subunit in parallel; the second half-bridge DC/AC sub-module has its direct current input port connected to the second bus capacitor subunit in parallel; the first half-bridge DC/AC sub-module and the second half-bridge DC/AC sub-module respectively include a bridge arm neutral point, and the first capacitor unit connects the bridge arm neutral point of the first half-bridge DC/AC sub-module and the bridge arm neutral point of the second half-bridge DC/AC sub-module to the primary winding of the first transformer in series. On one hand, by connecting the direct current port of the AC/DC subunit to the direct current input port of the first DC/DC subunit, it is possible to make, under the same voltage, the topology of the power electronic conversion unit easier, the number of devices smaller, the withstand alternating current voltage higher, the power density higher and the conduction loss smaller; on the other hand, in a power electronic conversion system formed on the basis of the power electronic conversion unit, the number of cascaded power electronic conversion units is smaller, the topology for the system is simple, and the costs are lower.

### BRIEF DESCRIPTION OF DRAWINGS

In order to make technical solutions in embodiments of the present disclosure or the prior art clearer, accompanying drawings used for description of the embodiments or the prior art will be briefly described hereunder. Obviously, the described drawings are merely some embodiments of present disclosure. For persons of ordinary skill in the art, other drawings may be obtained based on these drawings without any creative effort.

FIG. 1 is a schematic structural diagram of a power electronic transformer system in the prior art;

FIG. 2 is a schematic structural diagram of a power electronic transformer unit in the prior art;

FIG. 3 is a schematic structural diagram of another power electronic transformer unit in the prior art;

FIG. 4 is a schematic structural diagram of yet another power electronic transformer unit in the prior art;

FIG. 5 is a schematic structural diagram of still another power electronic transformer unit in the prior art;

FIG. 6 is a schematic structural diagram of a power electronic conversion unit according to an embodiment of the present disclosure;

FIG. 7 is a schematic structural diagram of another power electronic conversion unit according to an embodiment of the present disclosure;

FIG. 8 is a schematic structural diagram of yet another power electronic conversion unit according to an embodiment of the present disclosure;

FIG. 9 shows a schematic structural diagram of a power electronic conversion unit according to a first preferred exemplary embodiment of the present disclosure;

FIG. 10 shows a schematic structural diagram of a power electronic conversion unit according to a second preferred exemplary embodiment of the present disclosure;

FIG. 11 shows a schematic structural diagram of a power electronic conversion unit according to a third preferred exemplary embodiment of the present disclosure;

FIG. 12 shows a schematic structural diagram of a power electronic conversion unit according to a fourth preferred exemplary embodiment of the present disclosure;

FIG. 13 shows a first power electronic conversion system based on the power electronic conversion unit in the first preferred embodiment of FIG. 9;

FIG. 14 shows a second power electronic conversion system based on the power electronic conversion unit in the first preferred embodiment of FIG. 9;

FIG. 15 shows a third power electronic conversion system based on the power electronic conversion unit in the second preferred embodiment of FIG. 10;

FIG. 16 shows a fourth power electronic conversion system based on the power electronic conversion unit in the second preferred embodiment of FIG. 10;

FIG. 17 shows a fifth power electronic conversion system based on the power electronic conversion unit in the third preferred embodiment of FIG. 11;

FIG. 18 shows a sixth power electronic conversion system based on the power electronic conversion unit in the third preferred embodiment of FIG. 11; and

FIG. 19 shows a seventh power electronic conversion system based on the power electronic conversion unit in the fourth preferred embodiment of FIG. 12.

### DESCRIPTION OF EMBODIMENTS

In order to make objectives, technical solutions and advantages of the embodiments of the present disclosure clearer, the technical solutions in the embodiments of the present disclosure will be described hereunder clearly and completely with reference to the accompanying drawings in the embodiments of the present disclosure. Obviously, the described embodiments are a part of embodiments of the present disclosure, rather than all embodiments of the present disclosure. All other embodiments obtained by persons of ordinary skill in the art based on the embodiments of the present disclosure without any creative effort should fall into the protection scope of the present disclosure.

Terms such as “first”, “second”, “third”, “fourth”, etc. (if present) in the specification and the claims as well as the described accompany drawings of the present disclosure are used to distinguish similar objects, but not intended to describe a specific order or sequence. It will be appreciated that the data used in this way may be interchangeable under appropriate circumstances, such that the embodiments of the present disclosure described herein can be implemented in an order other than those illustrated or described herein, for instance. Moreover, terms such as “include” and “have” and any variation thereof are intended to cover a non-exclusive inclusion, e.g., processes, methods, systems, products or devices that encompass a series of steps or units are not necessarily limited to those steps or units that are clearly listed, but may include other steps or units that are not explicitly listed or inherent to these processes, methods, products or devices.

Further, the drawings are merely schematic representations of the present disclosure and are not necessarily drawn to scale. The same reference numerals in the drawings represent the same or similar parts, and thus a repetitive description thereof will be omitted. Some block diagrams as shown in the drawings are functional entities, and are not necessarily corresponding to physically- or logically-separated entities. These functional entities may be implemented in one or more hardware modules or integrated circuits.

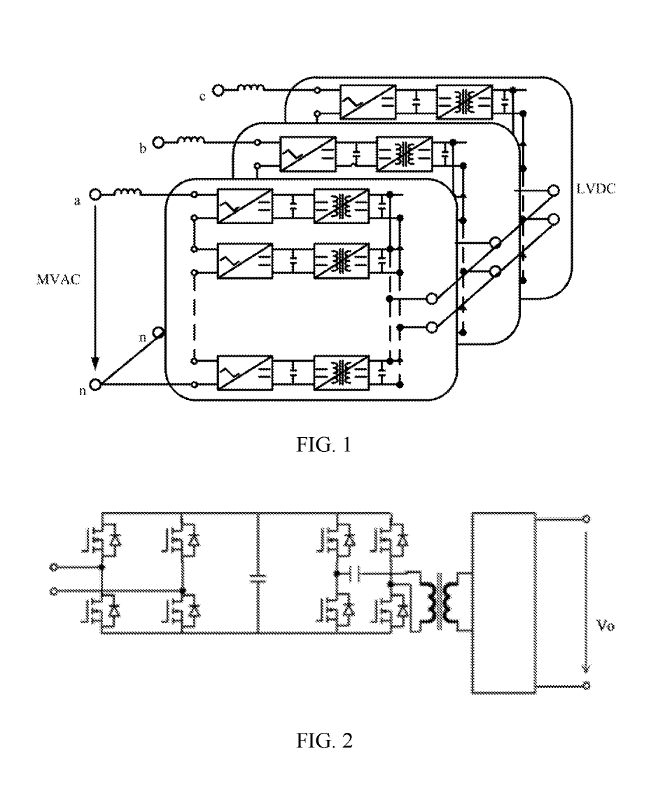

FIG. 2 is a schematic structural diagram of a power electronic conversion unit in the prior art. A technical solution used for a power electronic conversion unit of FIG. 1 is shown in FIG. 2. An AC/DC converter part at the front-stage of the power electronic conversion unit is an full-bridge, and isolation DC/DC converters at the rear-stage and the AC/DC converters at the front-stage are connected via a DC link capacitor. The DC/DC converters may be non-resonant converters, for example, pulse width modulation (Pulse Width Modulation; PWM) converters. The DC/DC converters may also be resonant converters. Since the AC/DC converters with structures of two-level full-bridge have a low withstand AC voltage, if a system input voltage of more than 10 kV is required, the system requires a large number of cascaded power electronic conversion units. Moreover, each unit needs corresponding isolation transformer, insulating shell, mechanical part, optical connector, etc.; therefore, the power electronic transformer system has relatively high complexity and costs. In the description, H-bridge may also be named as full-bridge.

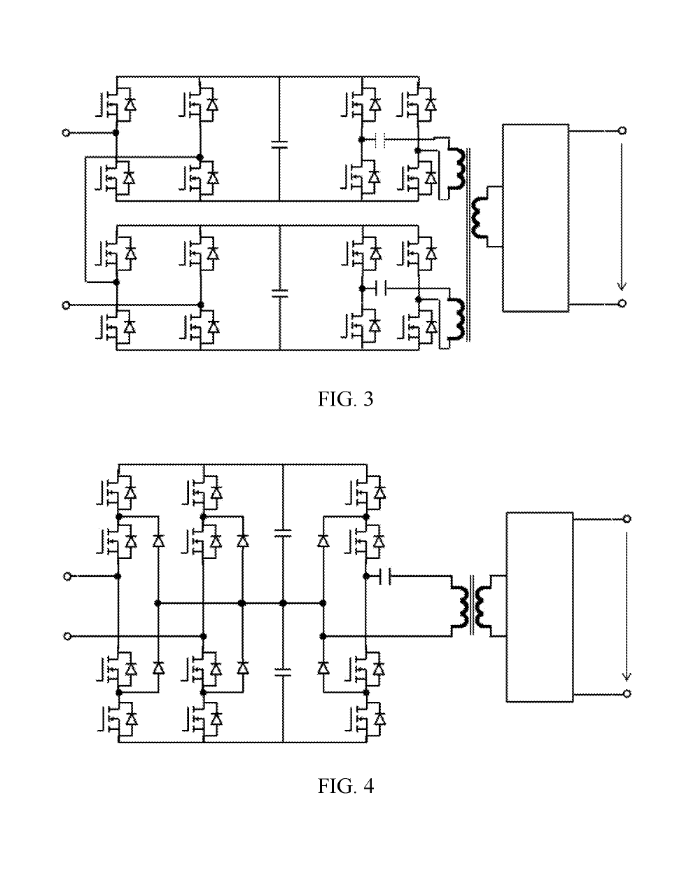

In order to fill up a deficiency of the power electronic conversion unit based on the two-level full-bridge scheme as shown in FIG. 2, an element topology based on the primary dual full-bridge structure is proposed in FIG. 3. The AC/DC converter part at the front-stage of the power electronic conversion unit is cascaded by two full-bridges, the isolation DC/DC converters at the rear-stage and the AC/DC converters at the front-stage are connected via two DC link capacitors. The DC/DC converters have two primary windings integrated in the same transformer, and the transformer is dual-winding input single-winding output. This unit topology differs from the topology in FIG. 2 in that, the number of switch tubes at the primary side becomes doubled, which can withstand twice the input voltage, achieving the purpose of reducing the number of cascaded units by half. For the entire system, the number of switch tubes is unchanged, the number of high-frequency transformers and fiber optic connectors are reduced by half, and system complexity is reduced. However, in the unit topology of FIG. 3, the transformer with double-winding input single-winding output has a complicated structure and its design is difficult.

In order to fill up a deficiency of the power electronic conversion unit based on the primary dual full-bridge scheme as shown in FIG. 3, an element topology based on a neutral-point-clamped three-level full-bridge structure is proposed in FIG. 4. This unit topology differs from the topology of FIG. 2 and FIG. 3 in that, the number of switch tubes at the primary side becomes doubled, which can withstand twice the input voltage, achieving the purpose of reducing the number of cascaded units by half. For the entire system, the number of switch tubes is unchanged, the number of isolation transformers is reduced by half, and the number of secondary rectification circuits is reduced by half. However, in the unit topology of FIG. 4, six clamped diodes are added in each unit, and the conduction loss of the diodes is larger than that of a metal-oxide-semiconductor field-effect transistor (MOSFET) at a low current, resulting in lower system efficiency. In summary, the use of the unit topology of FIG. 4 is detrimental to the costs and efficiency of the power electronic conversion system.

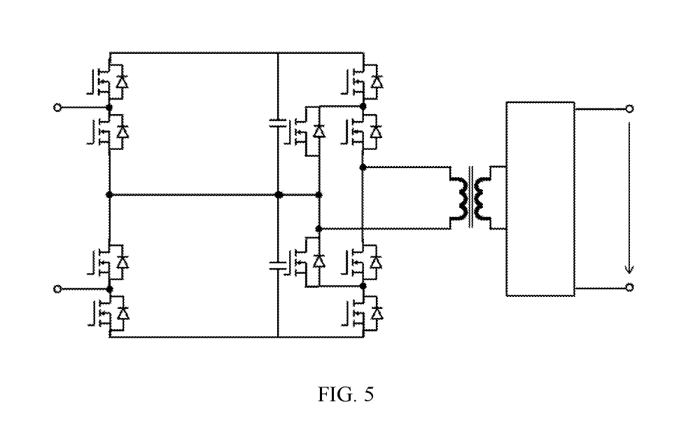

In order to fill up a deficiency of the power electronic conversion unit based on the neutral-point-clamped three-level full-bridge scheme as shown in FIG. 4, an unit topology with a three-level structure is proposed in FIG. 5. An AC/DC stage of the power electronic conversion unit has a dual two-level half-bridge serially-connected structure, which is composed of four switch tubes and is capable of generating three levels such as 0, 1 and 2.

Compared with the two-level structure, the number of cascades in this structure is reduced by half; however, this topology cannot generate a negative voltage, and is only applicable to a modular multilevel converter (MMC) system structure but not applicable to the CHB structure. Moreover, DC/DC at the rear-stage has a neutral-point-clamped three-level structure, where two clamping devices are added in each unit, resulting in an increase in costs.

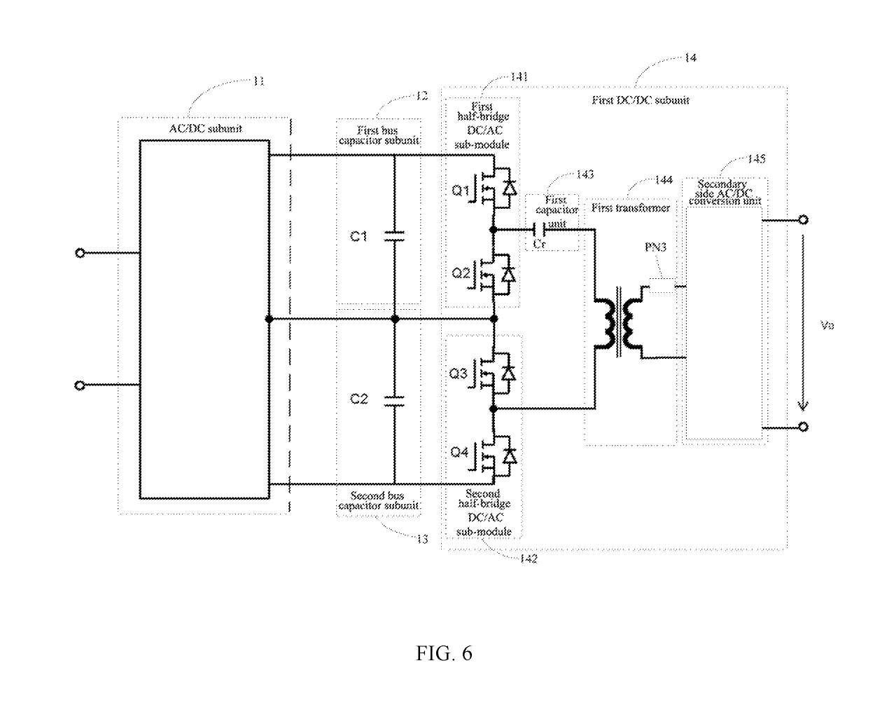

Based on the above description, it can be seen that design of an appropriate unit topology is the critical for the design of the power electronic conversion system. Therefore, in an exemplary embodiment of the present disclosure, a power electronic conversion unit is proposed, FIG. 6 is a schematic structural diagram of a power electronic conversion unit according to an embodiment of the present disclosure. As shown in FIG. 6, the power electronic conversion unit includes: an AC/DC subunit 11, a first bus capacitor subunit 12, a second bus capacitor subunit 13 and a first DC/DC subunit 14, where the AC/DC subunit 11 is a three-level circuit and includes a direct current output port; the first bus capacitor subunit 12 and the second bus capacitor subunit 13 are connected in series and then connected to the direct current output port of the AC/DC subunit 11; the first DC/DC subunit 14 includes a first half-bridge DC/AC sub-module 141, a second half-bridge DC/AC sub-module 142, a first capacitor unit 143 and a first transformer 144, where the first half-bridge DC/AC sub-module 141 has its direct current input port connected to the first bus capacitor subunit 12 in parallel; the second half-bridge DC/AC sub-module 142 has its direct current input port connected to the second bus capacitor subunit 13 in parallel; the first half-bridge DC/AC sub-module 141 and the second half-bridge DC/AC sub-module 142 respectively include a bridge arm neutral point, and the first capacitor unit 143 electrically connects the bridge arm neutral point of the first half-bridge DC/AC sub-module 141, the bridge arm neutral point of the second half-bridge DC/AC sub-module 142 and a primary winding of the first transformer 144 in series.

The first bus capacitor subunit 12 and the second bus capacitor subunit 13 are connected in series; the first half-bridge DC/AC sub-module 141 is connected to the first bus capacitor subunit 12 in parallel; the second half-bridge DC/AC sub-module 142 is connected to the second bus capacitor subunit 13 in parallel; then the two half-bridge DC/AC sub-modules are connected in series to form a dual half-bridge serially-connected structure, and this structure can withstand a higher voltage. Compared with the neutral-point-clamped three-level topology, the structure in the present embodiment may save clamping diodes, moreover, the system is more efficient because the conduction loss of the MOSFET is lower than that of the diodes. In addition, the two half-bridge DC/AC sub-modules are three-level modulated when they work simultaneously, and the two half-bridge DC/AC sub-modules are two-level modulated when they work alternately, in this case, the gain range is doubled, both the AC/DC subunit 11 at the front-stage and the first DC/DC subunit 14 at the rear-stage can control the balance of the neutral point voltage, rendering that the control is more flexible.

According to the power electronic conversion unit and the power electronic conversion system formed therefrom in the present embodiment, on one hand, by connecting the direct current port of the AC/DC subunit to the direct current input port of the first DC/DC subunit, it is possible to make, under the same voltage, the topology of the power electronic conversion unit easier, the number of devices required smaller, the withstand alternating current voltage higher, the power density higher and the conduction loss smaller; on the other hand, in the power electronic conversion system formed on the basis of the power electronic conversion unit, the number of cascaded power electronic conversion units is smaller, the topology for the system is simple, and the costs are lower.

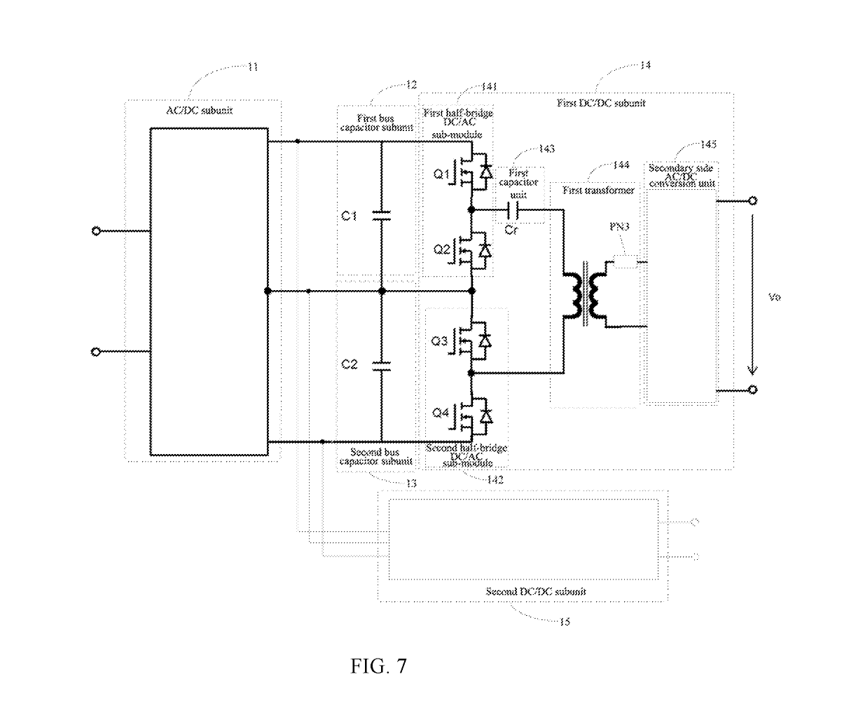

Alternatively, FIG. 7 is a schematic structural diagram of another power electronic conversion unit according to an embodiment of the present disclosure. As shown in FIG. 7, based on the topology in FIG. 6, the power electronic conversion unit also includes a second DC/DC subunit 15, where the second DC/DC subunit 15 has its direct current input port connected to the direct current output port of the AC/DC subunit 11. The second DC/DC subunit 15 may be the same as the first DC/DC subunit 14; likewise, the second DC/DC subunit 15 includes two serially-connected half-bridge DC/AC sub-modules, a second resonant capacitor unit and a second transformer; where the second transformer has two ends of its primary winding respectively electrically connected to the bridge arm neutral points of the two half-bridge DC/AC sub-modules. Specifically, a third half-bridge DC/AC sub-module has its direct current input port connected to the first bus capacitor subunit in parallel; a fourth half-bridge DC/AC sub-module has its direct current input port connected to the second bus capacitor subunit in parallel; the third half-bridge DC/AC sub-module and the fourth half-bridge DC/AC sub-module respectively include a bridge arm neutral point, and the second capacitor unit electrically connects the bridge arm neutral point of the third half-bridge DC/AC sub-module, the bridge arm neutral point of the fourth half-bridge DC/AC sub-module and a primary winding of the second transformer in series.

Specifically, two sets of dual half-bridge serially-connected DC/DC subunits may be connected at the output side of the AC/DC subunit 11, and at least one DC/DC subunit includes an isolation transformer to generate two sets of isolated output ports. Two sets of different voltage loads may be connected to two sets of isolated output ports. In such a topology, by multiplexing the AC/DC subunit 11, the number of switching devices may be further reduced. Since the output is isolated, the system structure is simple and the application is more flexible. It should be noted that each AC/DC subunit 11 is not limited to being connected with two sets of DC/DC subunits, but may be connected to a plurality of DC/DC subunits. Multiple sets of isolated output ports may be provided. For the number of DC/DC subunits connected after the AC/DC subunit 11, it is not limited in the embodiments of the present disclosure.

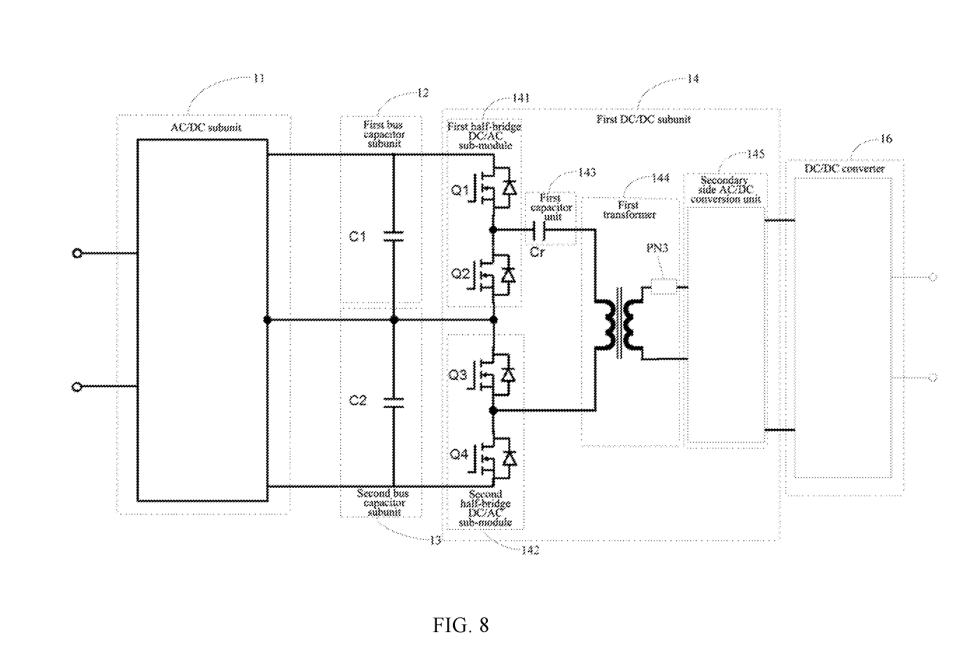

Alternatively, FIG. 8 is a schematic structural diagram of yet another power electronic conversion unit according to an embodiment of the present disclosure. As shown in FIG. 8, based on the topology in FIG. 6, the power electronic conversion unit also includes a DC/DC converter 16, where the DC/DC converter 16 has its direct current input port connected to the direct current output port of the first DC/DC subunit 14.

Specifically, a stage of a DC/DC converter 16 with an non-isolated wide gain range may be further connected after the first DC/DC subunit 14, where the DC/DC converter 16 has its direct current input port connected to the direct current output port of the first DC/DC subunit 14, in this case, the three-stage structure may be used to further increase an output voltage range of each unit and reduce the number of system units, thus, it may be adapted to a variety of load applications. It should be noted that, the first DC/DC subunit 14 is not limited to being connected with a set of DC/DC converter 16, but also may be connected to a plurality of DC/DC converters to generate a multi-port output. For the number of DC/DC converters 16 connected after the first DC/DC subunit 14, it is not limited in the embodiments of the present disclosure.

Alternatively, the AC/DC subunit may be a neutral-point-clamped three-level full-bridge circuit, a flying capacitor three-level full-bridge circuit or a serial half-bridge circuit. The AC/DC subunit may be a bidirectional conversion circuit.

Alternatively, the first DC/DC subunit 14 and the second DC/DC subunit 15 are three-level DC/DC converters, where the three-level DC/DC converter may reduce a voltage stress on a switch tube, therefore, the power electronic conversion unit is applicable to a system where the input and output voltages are relatively high. The first DC/DC subunit 14 and the second DC/DC subunit 15 may be bidirectional converters.

Alternatively, in the present exemplary embodiment, the power electronic conversion unit may also include a secondary side AC/DC conversion unit 145, where the secondary side AC/DC conversion unit 145 has its alternating current port connected to a secondary side winding of the first transformer 144, which is configured to receive an alternating current from the secondary side winding or output an alternating current to the secondary side winding.

Further, in order to filter out an unwanted voltage component, the power electronic conversion unit may also include a passive network PN3 containing a capacitor and/or an inductor, and the secondary side AC/DC conversion unit 145 has its alternating current port connected to a secondary winding of the transformer via the passive network PN3. It should be noted that, in the present exemplary embodiment, the power electronic conversion unit may not include the passive network PN3, that is, the secondary side AC/DC conversion unit 145 may also have its alternating current port directly connected to the secondary winding of the transformer.

It should be noted that, in the present exemplary embodiment, the passive network PN3 may be a series resonant network or a parallel resonant network, or may be a network consisting of other inductors or capacitors, which are not limited in the present disclosure.

It should be noted that, in the present exemplary embodiment, the secondary side AC/DC conversion unit 145 may be a full-bridge rectification circuit, a full-wave rectification circuit, a bidirectional conversion circuit or the like, which is not specifically limited in the present embodiment, that is also to say, the secondary side AC/DC conversion unit 145 may enable electric energy to be transferred from left to right, from right to left, or enables electric energy to be transferred bi-directionally.

According to a power electronic conversion unit provided in embodiments of the present disclosure, it is possible to make, under the same voltage, the topology of the power electronic conversion unit easier, the number of devices required smaller, the withstand alternating current voltage higher, the power density higher and the conduction loss smaller.

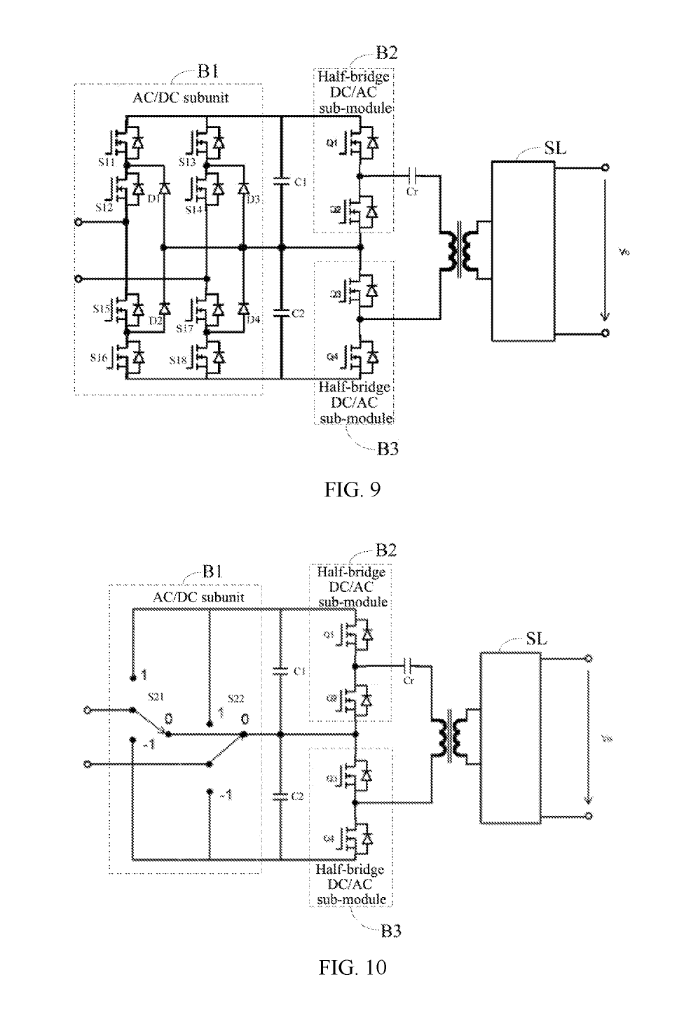

FIG. 9 shows a schematic structural diagram of a power electronic conversion unit according to a first preferred exemplary embodiment of the present disclosure. As shown in FIG. 9, the AC/DC subunit is a full-bridge circuit B1 consisting of two diode neutral-point-clamped (DNPC) three-level circuits. The two half-bridge DC/AC sub-modules are bridge arms B2 and B3, respectively. Working principles of the circuit will be briefly described by taking an example where electric power is transferred from left to right. The three-level full-bridge circuit B1 composed of diodes D1, D2, D3 and D4 and switch tubes S11, S12, S13, S14, S15, S16, S17 and S18 is a first rectification circuit, which converts an first alternating current into a direct current; the half-bridge circuit composed of switch tubes Q1 and Q2 and the half-bridge circuit composed of switch tubes Q3 and Q4 are connected in series, and are connected to a primary winding of the high-frequency isolation transformer to convert the direct current passing through a first bus capacitor subunit C1 and a second bus capacitor subunit C2 into a high frequency square wave voltage, that is, a second alternating current; a secondary side AC/DC conversion unit SL converts the high frequency square wave voltage at the secondary side into a low voltage direct current Vo. In the power electronic conversion unit, the AC/DC subunit is a full-bridge circuit consisting of two diode neutral-point-clamped (DNPC) three-level circuits, rendering that the withstand voltage of the circuit is high and the modulation is flexible. The circuits in FIG. 4 and FIG. 9 may be named as a neutral-point-clamped three-level full-bridge circuit.

In the present exemplary embodiment, Cr may be a resonant device forming a passive network, where the passive network may be used to filter out an unwanted voltage component or to adjust a waveform inputted into the primary winding. In addition, the passive network may also be an inductor. It should be noted that, in the present exemplary embodiment, the power electronic conversion unit may not include the passive network, that is, the two half-bridge DC/AC sub-modules may also have their bridge arm neutral points directly and respectively connected to both ends of the primary winding of the transformer, this also belongs to the protection scope of the present disclosure. Similarly, the secondary side of the power electronic conversion unit may also include a passive network, and details will not be repeated herein.

It should be noted that, in the present exemplary embodiment, all devices in the power electronic conversion unit can be bi-directionally operated, and the power electronic conversion unit may implement a bidirectional power conversion. In the present exemplary embodiment, as shown in FIG. 9, the switching devices are MOSFETs, but the switching device in the exemplary embodiments of the present disclosure is not limited thereto. For instance, the switching device may be other full-controlled switching devices such as an insulated gate bipolar transistor (IGBT), an integrated gate commutated thyristor (IGCT), a gate turn-off thyristor (GTO) or the like, which are also within the protection scope of the present disclosure.

Further, in the present exemplary embodiment, the two serially-connected half-bridge DC/AC sub-modules, the secondary side AC/DC conversion unit SL and the high frequency isolation transformer as described above may constitute an isolation DC/DC converter. It should be noted that the DC/DC converter may be a resonant converter or non-resonant converter. The DC/DC converter may be a PWM converter, but the DC/DC converter in the exemplary embodiments of the present disclosure is not limited thereto. For instance, the DC/DC converter may be other converters, such as a pulse frequency modulation (PFM) converter or the like, which also belong to the protection scope of the present disclosure. The above DC/DC converter may be a bidirectional converter, and a transfer direction of electric energy of the DC/DC converter is not limited in the present disclosure.

It should be noted that in the present exemplary embodiment, the secondary side AC/DC conversion unit SL may be a full-bridge rectification circuit, a full-wave rectification circuit, a bidirectional circuit or the like, which is not limited in the present disclosure.

FIG. 10 shows a schematic structural diagram of a power electronic conversion unit according to a second preferred exemplary embodiment of the present disclosure. As shown in FIG. 10, the power electronic conversion unit of the second preferred exemplary embodiment differs from the power electronic conversion unit of the first preferred exemplary embodiment in that, the AC/DC subunit of the power electronic conversion unit in the second preferred embodiment is a full-bridge circuit consisting of two neutral-point-clamped three-level bridge arms, of which the three-level bridge arm are not limited to a diode neutral-point-clamped (DNPC) topology, but may also be an active neutral-point-clamped (ANPC) topology or varieties of neutral-point-clamped three-level bridge arms such as a T-type three-level. The AC/DC subunit is a full-bridge circuit B1; and the first and second half-bridge DC/AC sub-modules are bridge arms B2 and B3, respectively.

Specifically, a first rectification circuit, which is formed by the full-bridge circuit B1, converts the input first alternating current into a direct current; the half-bridge circuit composed of switch tubes Q1 and Q2 and the half-bridge circuit composed of switch tubes Q3 and Q4 are connected in series and are connected to a primary winding of the high frequency isolation transformer. The switch tubes convert the direct current passing through the first bus capacitor subunit C1 and the second bus capacitor subunit C2 into a high frequency square wave voltage, that is, a second alternating current; a secondary side AC/DC conversion unit SL converts the high frequency square wave voltage at the secondary side into a low voltage direct current Vo. In the power electronic conversion unit, the AC/DC subunit is a full-bridge circuit consisting of two neutral-point-clamped three-level bridge arms, rendering that the withstand voltage for the circuit is high and the modulation is flexible.

It should be noted that other parts of the power electronic conversion unit in the second preferred exemplary embodiment of FIG. 10 are basically the same as those of the power electronic conversion unit in the first preferred exemplary embodiment of FIG. 9, and details will not be repeated herein.

FIG. 11 shows a schematic structural diagram of a power electronic conversion unit according to a third preferred exemplary embodiment of the present disclosure. As shown in FIG. 11, the power electronic conversion unit of the third preferred exemplary embodiment differs from the power electronic conversion unit of the first and second preferred exemplary embodiments in that, the AC/DC subunit of the power electronic conversion unit in the third preferred embodiment is a full-bridge circuit consisting of two flying capacitor three-level bridge arms; the AC/DC subunit is a full-bridge circuit B1, and the first and second half-bridge DC/AC sub-modules are bridge arms B2 and B3, respectively. The circuit in FIG. 11 may be named as flying capacitor three-level full-bridge circuit.

Specifically, the capacitor C3 and the switch tubes S31, S32, S35 and S36 form a first three-level bridge arm; the capacitor C4 and the switch tubes S33, S34, S37 and S38 form a second three-level bridge arm; a first rectification circuit, which is formed by a full-bridge circuit B1, converts the input first alternating current into a direct current; the half-bridge circuit composed of switch tubes Q1 and Q2 and the half-bridge circuit composed of switch tubes Q3 and Q4 are connected in series and are connected to a primary winding of the high frequency isolation transformer. The switch tubes convert the direct current passing through the first bus capacitor subunit C1 and the second bus capacitor subunit C2 into a high frequency square wave voltage, that is, a second alternating current; a secondary side AC/DC conversion unit SL converts the high-frequency square wave voltage at the secondary side into a low-voltage direct current Vo. In the power electronic conversion unit, the AC/DC subunit is a full-bridge circuit consisting of two flying capacitor three-level bridge arms, rendering that the withstand voltage for the circuit is high and the modulation is flexible.

It should be noted that other parts of the power electronic conversion unit in the third preferred exemplary embodiment of FIG. 11 are basically the same as those of the power electronic conversion unit in the first preferred exemplary embodiment of FIG. 9, and details will not be repeated herein.

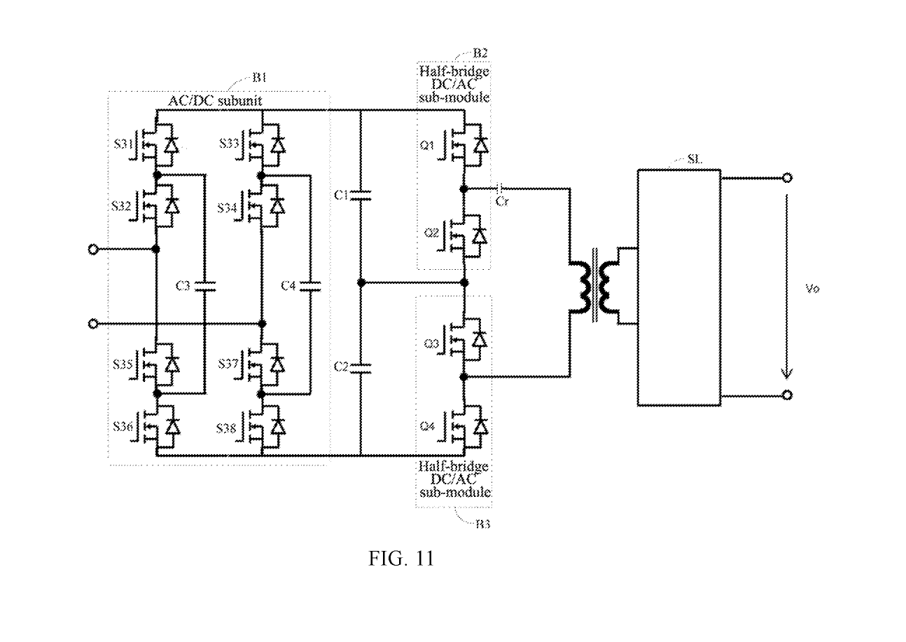

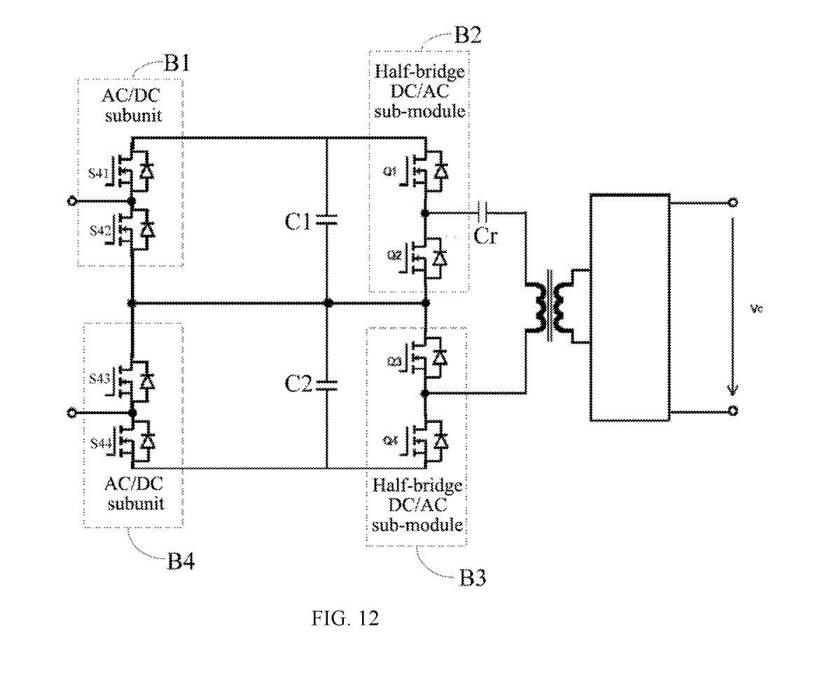

FIG. 12 shows a schematic structural diagram of a power electronic conversion unit according to a fourth preferred exemplary embodiment of the present disclosure. As shown in FIG. 12, the power electronic conversion unit of the fourth preferred exemplary embodiment differs from the power electronic conversion unit of the first to the third preferred exemplary embodiments in that, the AC/DC subunit of the power electronic conversion unit in the fourth preferred embodiment is two half-bridge circuits; the AC/DC subunit includes half-bridge circuits B1 and B4, and the two half-bridge DC/AC sub-modules are bridge arms B2 and B3, respectively. The circuit in FIG. 12 may be named as serial half-bridge circuit.

Specifically, the half-bridge circuit B1 composed of switch tubes S41 and S42 and the half-bridge circuit B4 composed of switch tubes S43 and S44 are cascaded to form a first rectification circuit, which converts the input first alternating current into a direct current; the half-bridge circuit composed of switch tubes Q1 and Q2 and the half-bridge circuit composed of switch tubes Q3 and Q4 are connected in series and are connected to a primary winding of the high-frequency isolation transformer. The switch tubes convert the direct current passing through the first bus capacitor subunit C1 and the second bus capacitor subunit C2 into a high frequency square wave voltage, that is, a second alternating current; a secondary side AC/DC conversion unit SL converts the high frequency square wave voltage at the secondary side into a low voltage direct current Vo. In the power electronic conversion unit, the AC/DC subunit is two half-bridge circuits, rendering that the withstand voltage for the circuit is high and the modulation is flexible. In addition, the two half-bridge circuits in the AC/DC subunit have the same structure as that of the half-bridge DC/AC sub-modules in the first DC/DC subunit at the rear-stage. It should be noted that the half-bridge serially-connected back-to-back units in the above topology are only limited to forming an MMC system, but the present disclosure is not limited thereto.

It should be noted that other parts of the power electronic conversion unit in the fourth preferred exemplary embodiment of FIG. 12 are basically the same as those of the power electronic conversion unit in the first preferred exemplary embodiment of FIG. 9, and details will not be repeated herein.

Moreover, embodiments of the present disclosure also provide a power electronic conversion system, where the system includes a plurality of power electronic conversion units as described in any one of the above embodiments. A system including the power electronic conversion unit as described above in FIG. 9 to FIG. 12 will be described hereunder in detail.

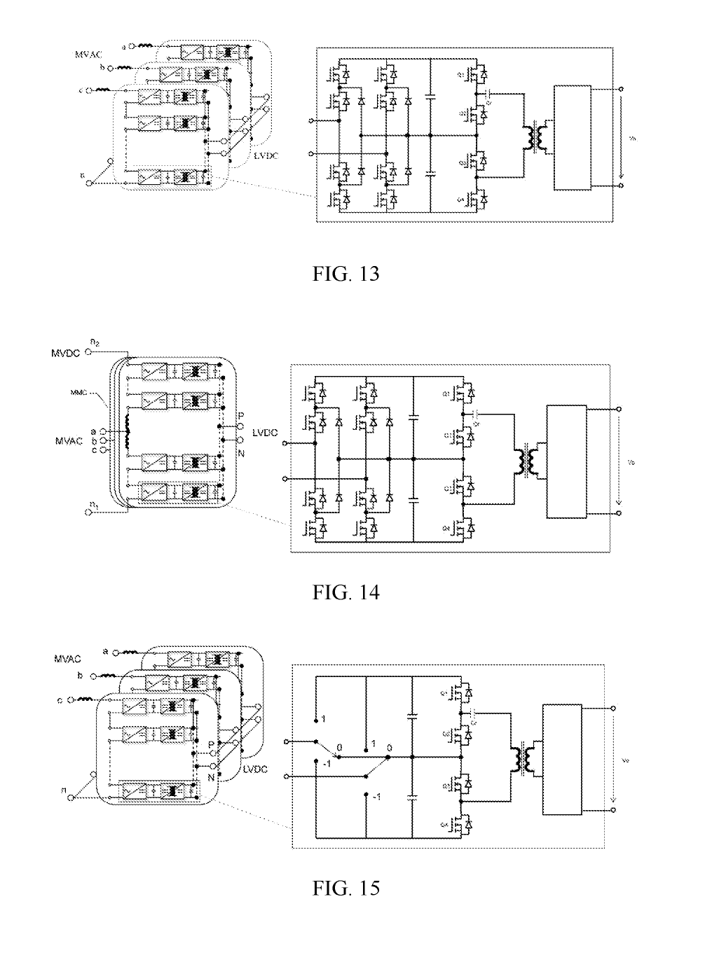

FIG. 13 shows a first power electronic conversion system based on the power electronic conversion unit in the first preferred embodiment of FIG. 9, where the power electronic conversion system may be connected to a medium voltage power grid via a reactor. As shown in FIG. 13, the left-hand side is the first power electronic conversion system based on the power electronic conversion unit in the first preferred embodiment; the right-hand side is the power electronic conversion unit in the first preferred embodiment; and a portion in a rectangle ring at the left-hand side is the power electronic conversion unit at the right-hand side. Each AC/DC subunit of the power electronic conversion unit in the power electronic conversion system is a full-bridge circuit consisting of two diode neutral-point-clamped (DNPC) three-level circuits. A plurality of power electronic conversion units have their first ports connected in series, and the serially-connected first ports may be connected to the medium voltage alternating current power grid MVAC via a reactor. In the present exemplary embodiment, AC/DC subunits of respective power electronic conversion units of the power electronic conversion system are cascaded to form a CHB (cascaded H-Bridge) structure.

Further, the power electronic conversion system may also include a plurality of secondary side AC/DC conversion units, where the plurality of secondary side AC/DC conversion units have their alternating current ports respectively connected to secondary windings of transformers of respective power electronic conversion units one by one, and the secondary side AC/DC conversion units of the respective power electronic conversion units have their direct current ports connected to form an LVDC port. It should be noted that, in the present exemplary embodiment, the secondary side AC/DC conversion units of the respective power electronic conversion units have their direct current ports connected in parallel, but the exemplary embodiments of the present disclosure are not limited thereto. For instance, the secondary side AC/DC conversion units of the respective power electronic conversion units may also have their direct current ports connected in series, or have a part of their direct current ports connected in series and a part of their direct current ports connected in parallel, or have their direct current ports independently output without connecting to each other, which is also within the protection scope of the present disclosure, that is, a manner in which the secondary side AC/DC conversion units have their direct current ports connected is not limited in the present disclosure. In addition, the power electronic conversion system as a whole may have a single-phase structure or a three-phase structure, which is not specially limited in the present disclosure. Taking FIG. 13 as an example, the power electronic conversion system as a whole has a three-phase structure, and the secondary side AC/DC conversion units of the respective power electronic conversion units have their direct current ports connected in parallel.

Next, a description will be made with reference to FIG. 14. FIG. 14 shows a second power electronic conversion system based on the power electronic conversion unit in the first preferred embodiment of FIG. 9. In the second power electronic conversion system, a plurality of cascaded power electronic conversion units have their first ports stacked in a connection mode of an MMC (Modular Multilevel Converter), and both an upper bridge arm and a lower bridge arm of the MMC structure are connected to the medium voltage alternating current power grid MVAC via a reactor. The other ends of the upper bridge arm and the lower bridge arm form a medium voltage direct current port of the MMC structure, which may be connected to the medium voltage direct current power grid (MVDC). It should be noted that the second power electronic conversion system may also include a plurality of secondary side AC/DC conversion units, where the plurality of secondary side AC/DC conversion units have their alternating current ports respectively connected to secondary windings of transformers of respective power electronic conversion units one by one, and the secondary side AC/DC conversion units of the respective power electronic conversion units have their direct current ports connected to form an LVDC port.

It should be noted that, in the present exemplary embodiment, the AC/DC subunits of the respective power electronic conversion units in the second power electronic conversion system are full-bridge circuits, but the exemplary embodiments of the present disclosure is not limited thereto. For instance, the AC/DC subunits may also be half-bridge circuits, or partially are full-bridge circuits and partially are half-bridge circuits or the like, which is also within the protection scope of the present disclosure.

FIG. 15 shows a third power electronic conversion system based on the power electronic conversion unit in the second preferred embodiment of FIG. 10, where the power electronic conversion system may be connected to a medium voltage power network via a reactor. As shown in FIG. 15, the left-hand side is the third power electronic conversion system based on the power electronic conversion unit in the second preferred embodiment; the right-hand side is the power electronic conversion unit in the second preferred embodiment; and a portion in a rectangle ring at the left-hand side is the power electronic conversion unit at the right-hand side. Each AC/DC subunit of the power electronic conversion unit in the power electronic conversion system is a full-bridge circuit consisting of two neutral-point-clamped three-level bridge arms. A plurality of power electronic conversion units have their first ports connected in series, and the serially-connected first ports may be connected to the medium voltage alternating current power network (MVAC) via a reactor. In the present exemplary embodiment, AC/DC subunits of respective power electronic conversion units of the power electronic conversion system are cascaded to form a CHB (cascaded H-Bridge) structure.

Further, the power electronic conversion system may also include a plurality of secondary side AC/DC conversion units, where the plurality of secondary side AC/DC conversion units have their alternating current ports respectively connected to secondary windings of transformers of respective power electronic conversion units one by one, and the secondary side AC/DC conversion units of the respective power electronic conversion units have their direct current ports connected to form an LVDC port. It should be noted that, in the present exemplary embodiment, the secondary side AC/DC conversion units of the respective power electronic conversion units have their direct current ports connected in parallel, but the exemplary embodiments of the present disclosure are not limited thereto. For instance, the secondary side AC/DC conversion units of the respective power electronic conversion units may also have their direct current ports connected in series, or have a part of their direct current ports connected in series and a part of their direct current ports connected in parallel, or have their direct current ports independently output without connecting to each other, which is also within the protection scope of the present disclosure, that is, a manner in which the secondary side AC/DC conversion units have their direct current ports connected is not limited in the present disclosure. In addition, the power electronic conversion system as a whole may have a single-phase structure or a three-phase structure, which is not specially limited in the present disclosure. Taking FIG. 15 as an example, the power electronic conversion system as a whole has a three-phase structure, and the secondary side AC/DC conversion units of the respective power electronic conversion units have their direct current ports connected in parallel.

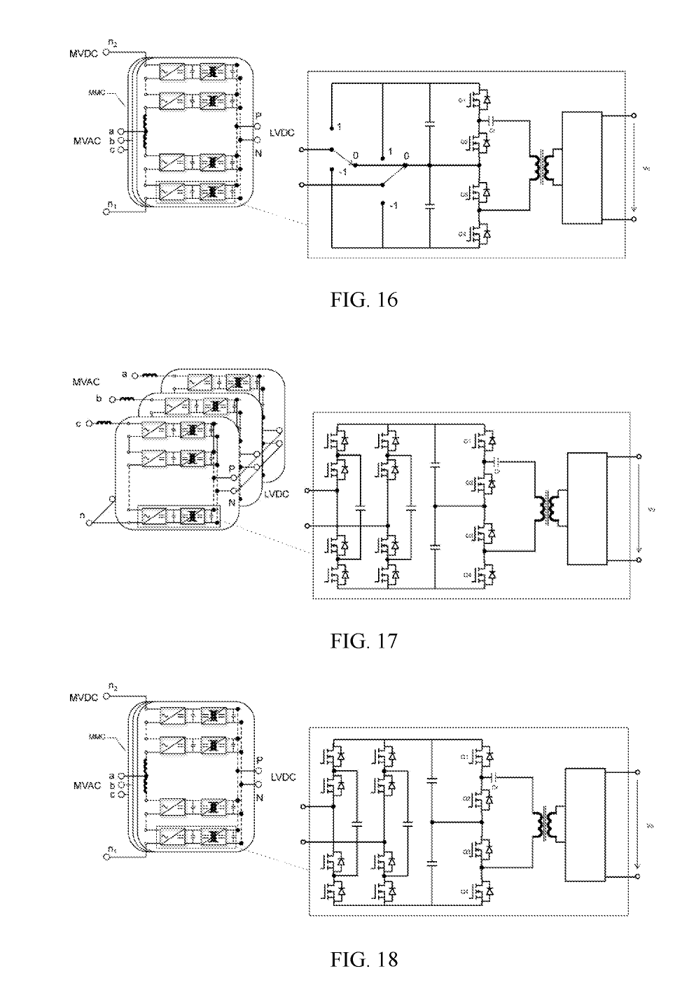

Next, a description will be made with reference to FIG. 16. FIG. 16 shows a fourth power electronic conversion system based on the power electronic conversion unit in the second preferred embodiment of FIG. 10. In the fourth power electronic conversion system, a plurality of cascaded power electronic conversion units have their first ports stacked in a connection mode of an MMC (Modular Multilevel Converter), and both an upper bridge arm and a lower bridge arm of the MMC structure are connected to the medium voltage alternating current power grid MVAC via a reactor. The other end of the upper bridge arm and the lower bridge arm forms a medium voltage direct current port of the MMC structure, which may be connected to the medium voltage direct current power grid (MVDC). It should be noted that the fourth power electronic conversion system may also include a plurality of secondary side AC/DC conversion units, where the plurality of secondary side AC/DC conversion units have their alternating current ports respectively connected to secondary windings of transformers of respective power electronic conversion units one by one, and the secondary side AC/DC conversion units of the respective power electronic conversion units have their direct current ports connected to form an LVDC port.

It should be noted that, in the present exemplary embodiment, the AC/DC subunits of the respective power electronic conversion units in the fourth power electronic conversion system are full-bridge circuits, but the exemplary embodiments of the present disclosure is not limited thereto. For instance, the AC/DC subunits may also be half-bridge circuits, or partially are full-bridge circuits and partially are half-bridge circuits or the like, which is also within the protection scope of the present disclosure.

FIG. 17 shows a fifth power electronic conversion system based on the power electronic conversion unit in the third preferred embodiment of FIG. 11, where the power electronic conversion system may be connected to a medium voltage power grid via a reactor. As shown in FIG. 17, the left-hand side is the fifth power electronic conversion system based on the power electronic conversion unit in the third preferred embodiment; the right-hand side is the power electronic conversion unit in the third preferred embodiment; and a portion in a rectangle ring at the left-hand side is the power electronic conversion unit at the right-hand side. Each AC/DC subunit of the power electronic conversion unit in the power electronic conversion system is a full-bridge circuit consisting of two flying capacitor three-level bridge arms. A plurality of power electronic conversion units have their first ports connected in series, and the serially-connected first ports may be connected to the medium voltage alternating current power grid MVAC via a reactor. In the present exemplary embodiment, AC/DC subunits of respective power electronic conversion units of the power electronic conversion system are cascaded to form a CHB (cascaded H-Bridge) structure.

Further, the power electronic conversion system may also include a plurality of secondary side AC/DC conversion units, where the plurality of secondary side AC/DC conversion units have their alternating current ports respectively connected to secondary windings of transformers of respective power electronic conversion units one by one, and the secondary side AC/DC conversion units of the respective power electronic conversion units have their direct current ports connected to form an LVDC port. It should be noted that, in the present exemplary embodiment, the secondary side AC/DC conversion units of the respective power electronic conversion units have their direct current ports connected in parallel, but the exemplary embodiments of the present disclosure are not limited thereto. For instance, the secondary side AC/DC conversion units of the respective power electronic conversion units may also have their direct current ports connected in series, or have a part of their direct current ports connected in series and a part of their direct current ports connected in parallel, or have their direct current ports independently output without connecting to each other, which is also within the protection scope of the present disclosure, that is, a manner in which the secondary side AC/DC conversion units have their direct current ports connected is not limited in the present disclosure. In addition, the power electronic conversion system as a whole may have a single-phase structure or a three-phase structure, which is not specially limited in the present disclosure. Taking FIG. 17 as an example, the power electronic conversion system as a whole has a three-phase structure, and the secondary side AC/DC conversion units of the respective power electronic conversion units have their direct current ports connected in parallel.

Next, a description will be made with reference to FIG. 18. FIG. 18 shows a sixth power electronic conversion system based on the power electronic conversion unit in the third preferred embodiment of FIG. 11. In the sixth power electronic conversion system, a plurality of cascaded power electronic conversion units have their first ports stacked in a connection mode of an MMC (Modular Multilevel Converter), and both an upper bridge arm and a lower bridge arm of the MMC structure are connected to the medium voltage alternating current power grid MVAC via a reactor. The other ends of the upper bridge arm and the lower bridge arm form a medium voltage direct current port of the MMC structure, which may be connected to the medium voltage direct current power grid (MVDC). It should be noted that the sixth power electronic conversion system may also include a plurality of secondary side AC/DC conversion units, where the plurality of secondary side AC/DC conversion units have their alternating current ports respectively connected to secondary windings of transformers of respective power electronic conversion units one by one, and the secondary side AC/DC conversion units of the respective power electronic conversion units have their direct current ports connected to form an LVDC port.

It should be noted that, in the present exemplary embodiment, the AC/DC subunits of the respective power electronic conversion units in the sixth power electronic conversion system are full-bridge circuits, but the exemplary embodiments of the present disclosure are not limited thereto. For instance, the AC/DC subunits may also be half-bridge circuits, or partially are full-bridge circuits and partially are half-bridge circuits or the like, which is also within the protection scope of the present disclosure.

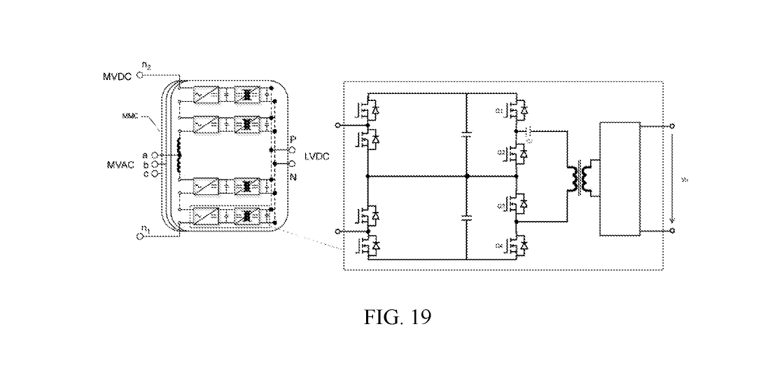

FIG. 19 shows a seventh power electronic conversion system based on the power electronic conversion unit in the fourth preferred embodiment of FIG. 12. In this power electronic conversion system, a plurality of cascaded power electronic conversion units have their first ports stacked in a connection mode of an MMC (Modular Multilevel Converter). Both an upper bridge arm and a lower bridge arm of the MMC structure are connected to the medium voltage alternating current power grid MVAC via a reactor. The other ends of the upper bridge arm and the lower bridge arm form a medium voltage direct current port of the MMC structure, which may be connected to the medium voltage direct current power grid (MVDC). It should be noted that the seventh power electronic conversion system may also include a plurality of secondary side AC/DC conversion units, where the plurality of secondary side AC/DC conversion units have their alternating current ports respectively connected to secondary windings of transformers of respective power electronic conversion units one by one, and the secondary side AC/DC conversion units of the respective power electronic conversion units have their direct current ports connected to form an LVDC port.

It should be noted that, in FIG. 14, FIG. 16, FIG. 18 and FIG. 19, the secondary side AC/DC conversion units of the respective power electronic conversion units may have their direct current ports connected in parallel, or connected in series, or have a part of their direct current ports connected in series and a part of their direct current ports connected in parallel, or have their direct current ports independently output without connecting to each other, which is not specially limited here in the present disclosure. In addition, the power electronic conversion system as a whole may have a single-phase structure or a three-phase structure. Taking FIG. 14, FIG. 16, FIG. 18 and FIG. 19 as examples, the power electronic conversion system as a whole has a three-phase structure, and the secondary side AC/DC conversion units of the respective power electronic conversion units have their direct current ports connected in parallel.

It should be noted that application fields of the power electronic conversion unit and the power electronic conversion system in the present disclosure include, but are not limited to, a medium-and-high voltage power electronic transformer system, a grid-connected inverter system, an energy storage inverter system, a new power generation system, a charging post or a charging station, a data center, an electrified transportation system, a micro-grid system consisting of distributed power generation units, energy storage units and local loads, etc.

Finally, it should be noted that the foregoing embodiments are merely intended for describing the technical solutions of the present disclosure rather than limiting the present disclosure. Although the present disclosure is described in detail with reference to the foregoing embodiments, persons of ordinary skill in the art should understand that they may still make modifications to the technical solutions described in the foregoing embodiments, or make equivalent replacements to some or all technical features therein; however, these modifications or replacements do not make the essence of corresponding technical solutions depart from the scope of the technical solutions in the embodiments of the present disclosure.

What is claimed is:

1. A power electronic conversion unit, comprising: an AC/DC subunit, a first bus capacitor subunit, a second bus capacitor subunit and a first DC/DC subunit,
wherein the AC/DC subunit is a three-level circuit and comprises a direct current output port;
the first bus capacitor subunit and the second bus capacitor subunit are connected in series and are connected to the direct current output port of the AC/DC subunit;
the first DC/DC subunit comprises a first half-bridge DC/AC sub-module, a second half-bridge DC/AC sub-module, a first capacitor unit and a first transformer, wherein a direct current input port of the first half-bridge DC/AC sub-module is connected to the first bus capacitor subunit in parallel; a direct current input port of the second half-bridge DC/AC sub-module is connected to the second bus capacitor subunit in parallel; the first half-bridge DC/AC sub-module and the second half-bridge DC/AC sub-module respectively comprise a bridge arm neutral point, and the first capacitor unit connects the bridge arm neutral point of the first half-bridge DC/AC sub-module, the bridge arm neutral point of the second half-bridge DC/AC sub-module and a primary winding of the first transformer in series.

2. The power electronic conversion unit according to claim 1, wherein the power electronic conversion unit further comprises a second DC/DC subunit, the second DC/DC subunit comprises a third half-bridge DC/AC sub-module, a fourth half-bridge DC/AC sub-module, a second capacitor unit and a second transformer, a direct current input port of the third half-bridge DC/AC sub-module is connected to the first bus capacitor subunit in parallel; a direct current input port of the fourth half-bridge DC/AC sub-module is connected to the second bus capacitor subunit in parallel; the third half-bridge DC/AC sub-module and the fourth half-bridge DC/AC sub-module respectively comprise a bridge arm neutral point, and the second capacitor unit connects the bridge arm neutral point of the third half-bridge DC/AC sub-module, the bridge arm neutral point of the fourth half-bridge DC/AC sub-module and a primary winding of the second transformer in series.

3. The power electronic conversion unit according to claim 1, wherein the AC/DC subunit is one of a neutral-point-clamped three-level full-bridge circuit, a flying capacitor three-level full-bridge circuit and a serial half-bridge circuit.

4. The power electronic conversion unit according to claim 1, wherein the first DC/DC subunit further comprises a secondary side AC/DC conversion unit, and an alternating current port of the secondary side AC/DC conversion unit is connected to a secondary winding of the first transformer.

5. The power electronic conversion unit according to claim 4, wherein the first DC/DC subunit further comprises a passive network containing a capacitor and/or an inductor, and the secondary side AC/DC conversion unit is connected to the secondary winding of the first transformer via the passive network.

6. The power electronic conversion unit according to claim 5, wherein the passive network is one of a series resonant network and a parallel resonant network.

7. The power electronic conversion unit according to claim 4, wherein the secondary side AC/DC conversion unit is one of a full-bridge rectification circuit, a full-wave rectification circuit, and a bidirectional conversion circuit.

8. The power electronic conversion unit according to claim 1, wherein the AC/DC subunit and the first DC/DC subunit are bidirectional conversion circuits.

9. The power electronic conversion unit according to claim 2, wherein the second DC/DC subunit further comprises a secondary side AC/DC conversion unit, and an alternating current port of the secondary side AC/DC conversion unit is connected to a secondary winding of the second transformer.

10. The power electronic conversion unit according to claim 2, wherein the second DC/DC subunit is a bidirectional conversion circuit.

11. The power electronic conversion unit according to claim 4, further comprising a DC/DC converter, wherein a direct current input port of the DC/DC converter is connected to a direct current output port of the secondary side AC/DC conversion unit.

12. The power electronic conversion unit according to claim 9, further comprising at least one DC/DC converter, wherein a direct current input port of the at least one DC/DC converter is connected to a direct current output port of the secondary side AC/DC conversion unit.

13. A power electronic conversion system, comprising a plurality of power electronic conversion units according to claim 1.

14. The power electronic conversion system according to claim 13, wherein the respective AC/DC subunits of the plurality of power electronic conversion units are full-bridge conversion units, and first ports of the plurality of power electronic conversion units are connected in series to form a cascaded H-Bridge structure.

15. The power electronic conversion system according to claim 13, wherein the respective AC/DC subunits of the plurality of power electronic conversion units are one of full-bridge conversion circuits and half-bridge circuits, and first ports of the plurality of power electronic conversion units are connected in series to respectively form an upper bridge arm and a lower bridge arm of an MMC structure.

16. The power electronic conversion system according to claim 13, wherein direct current ports of the plurality of secondary side AC/DC conversion units are one of all connected in parallel, all connected in series, partially connected in parallel and partially connected in series, and mutually disconnected from each other.
